(19) United States
(12) Patent Application Publication
(10) Pub. No.: US 2021/0314871 A1
(43) Pub. Date: Oct. 7, 2021

(54) WIRELESS SENSOR READER WITH SOFTWARE-CONTROLLED POWER EXCITER AND METHOD FOR OPERATING THE SAME

(71) Applicant: Analog Devices, Inc., Norwood, MA (US)

(72) Inventors: Yosef Stein, Sharon, MA (US); Eamon Nash, Chicago, IL (US)

(73) Assignee: Analog Devices, Inc., Norwood, MA (US)

(21) Appl. No.: 16/840,274

(22) Filed: Apr. 3, 2020

(51) Int. Cl. H04W 52/02

(52) U.S. Cl. CPC H04W 52/0274; H04W 52/0216; H04W 52/0229

(57) ABSTRACT

A reader apparatus with software-controller power exciter, and methods for operating the same to wirelessly interrogate an environmental or structural sensor are disclosed. Some aspects of the application are directed to a reader apparatus that transmits high power for a fast cold start of a sensor and subsequently switch to low power transmission in response to an indication signal received from the sensor indicating that a state of charge of the sensor has reached a threshold value such that high power transmission is no longer necessary, thereby extending battery life of the reader apparatus.

### FIELD OF THE DISCLOSURE

The present application relates to wireless sensor systems capable of reading data wirelessly from an environmental or structural sensor.

### BACKGROUND

Sensors are devices that are sometimes used for sensing various environmental conditions or structural health conditions. Environmental or structural sensors sense a condition of interest and communicate in a wired or wireless fashion with a reader apparatus. Multiple sensors may be deployed to monitor multiple spatial locations of a structure or an environment, and these sensors may also be referred to as sensor nodes.

Sometimes a sensor communicates with a reader using a wireless transceiver and antennas included in the sensor. The sensor uses an external or battery-powered energy source to operate the transceiver and/or other components of the sensor.

Inclusion of a battery-powered energy source and a transceiver results in a bulky sensor that consumes high power, usually in the range of 1-10 milliwatts. Also, such a sensor cannot be readily deployed at certain locations/sites where smaller packaging is desirable.

### SUMMARY OF THE DISCLOSURE

A reader apparatus with software-controlled power exciter, and methods for operating the same to wirelessly interrogate an environmental or structural sensor are disclosed. Some aspects of the application are directed to a reader apparatus that transmits higher power for a fast cold start of a sensor and subsequently switches to lower power transmission in response to a data signal received from the sensor indicating that a state of charge of the sensor has reached a threshold value such that higher power transmission is no longer necessary. Operation in this manner may extend battery life of the reader apparatus.

In some embodiments, a portable reader for wirelessly interrogating a sensor is provided. The portable reader may include one or more antennas configured to transmit a power signal to the sensor and to receive an indication signal from the sensor; a power amplifier (PA) configured to generate the power signal for transmission by the one or more antennas, and a controller configured to reduce a magnitude of the power signal in response to an indication from the indication signal that a state of charge of the sensor reaches a threshold value.

In some embodiments, an apparatus for wirelessly interrogating a structural sensor affixed to a structure is provided. The structural sensor may comprise an energy storage unit configured to be charged by a radio-frequency (RF) power signal. The apparatus may include one or more antennas; a power amplifier (PA) configured to generate the RF power signal for transmission to the structural sensor via the one or more antennas, and a controller coupled to a control terminal of the PA and configured to decrease a magnitude of the generated RF power signal in response to an indication signal received from the structural sensor indicating that a state of charge of the energy storage unit in the structural sensor reaches a threshold value.

In some embodiments, a method for operating a handheld reader to interrogate a sensor is provided. The method may include generating, with a power amplifier (PA), a first radio-frequency (RF) power signal having a first power level; transmitting, by one or more antennas, the first RF power signal to turn on the sensor from an off state; receiving an indication signal from the sensor; determining whether the indication signal indicates that a state of charge of the sensor has reached a threshold value; and in response to determining that the indication signal indicates the state of charge of the sensor has reached the threshold value: generating, with the PA, a second RF power signal having a second power level lower than the first power level, and transmitting, by the one or more antennas, the second RF power signal to the sensor.

### BRIEF DESCRIPTION OF THE DRAWINGS

Various aspects and embodiments of the application will be described with reference to the following figures. It should be appreciated that the figures are not necessarily drawn to scale. Items appearing in multiple figures are indicated by the same reference number in all the figures in which they appear. In the drawings:

FIG. 1 is a high level schematic diagram illustrating a reading operation using a reader apparatus in accordance with some embodiments;

FIG. 2 is a schematic diagram of an exemplary reader that can be used in the manner of FIG. 1 to interrogate a sensor, in accordance with some embodiments;

FIG. 3A is a flow diagram illustrating an exemplary process for operating a handheld reader of the type as illustrated in FIG. 2, in accordance with some embodiments;

FIG. 3B is a simulated data plot of an output power of a power signal as a function of elapsed time, in accordance with some embodiments;

FIG. 4 is a schematic diagram illustrating an exemplary implementation of a reader for interrogating a sensor, in accordance with some embodiments;

FIG. 5 is a schematic diagram of a reader apparatus that is a variation of the reader as shown in FIG. 4, in accordance with some embodiments;

FIG. 6 is a schematic diagram of a reader apparatus that is another variation of the reader as shown in FIG. 4, in accordance with some embodiments.

### DETAILED DESCRIPTION

Aspects of the present application allow for a reader apparatus that transmits relatively high power for a fast cold start of a sensor and subsequently switch to relatively low power transmission in response to an indication signal received from the sensor indicating that high power transmission is no longer necessary. In this manner, battery life of the reader apparatus can be extended.

Some aspects of the present application are directed to a wireless integrity sensing platform, which includes sensors that may be adhered to the structure of interest, and may permanently change state if and when the structure permanently changes state. In this manner, the sensor may record the condition of interest without being powered, and without needing to transmit or receive signals. At a desired time, a reader apparatus may be used to wirelessly power the sensor and read the recorded condition from the sensor.

A reader apparatus may be a portable, handheld reader that is powered by a battery. The inventors have recognized and appreciated that when a sensor is wirelessly powered from a reader, a relatively high power may be transmitted initially to charge (or recharge) an energy storage unit such as a rechargeable battery or a capacitor within the sensor. Once the energy storage unit's state of charge is at or above a pre-determined threshold, the reader can change to a lower transmit power to prolong the battery life of the reader.

In some embodiments, the reader has a software-controlled power amplifier (PA) that generates a power signal for transmitting power to the sensor via one or more antennas. The power signal may be at a higher level when the sensor is at a “cold start,” namely when the reader begins energy transfer with the sensor and the energy storage unit within the sensor has not been charged sufficiently to power operation within the sensor. By transmitting at a higher power signal during cold start, the delay time to wait for the sensor to begin operation can be shortened, increasing the operational efficiency of sensor data gathering using the wireless integrity sensing platform. Once the reader receives an indication signal from the sensor indicating that a state of the sensor has reached a threshold value, a controller within the reader will control the PA to reduce the magnitude of the power signal to extend the reader's battery life.

The aspects and embodiments described above, as well as additional aspects and embodiments, are described further below. These aspects and/or embodiments may be used individually, all together, or in any combination of two or more, as the application is not limited in this respect.

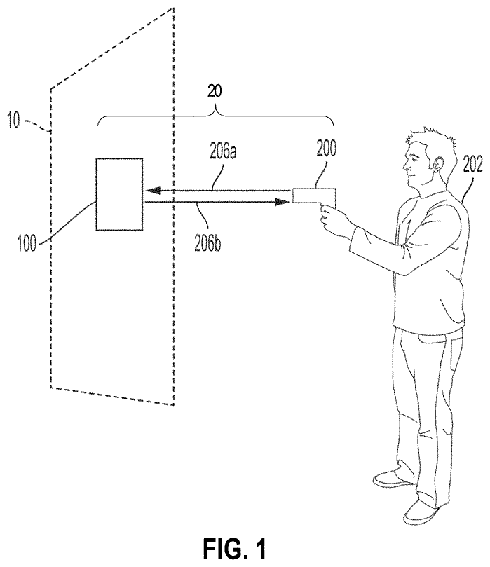

FIG. 1 is a high level schematic diagram illustrating a reading operation using a reader apparatus in accordance with some embodiments. FIG. 1 depicts a wireless integrity sensing platform (WISP) 20 that includes a sensor 100 and a reader 200 for wirelessly interrogating the sensor 100. Sensor 100 may be a sensor node disposed in an environment of interest to sense a condition of interest. For example, sensor 100 may be attached, mounted to, or placed near, an environmental or structural component 10 (e.g., a wall, building, parts of a vehicle, or other component). A condition of the component 10 or the surrounding environment may be monitored using the sensor 100.

In some applications, sensor 100 may be a passive sensor in that it is not consuming electric power when sensing the condition of component 10. In one example, sensor 100 may be a witness corrosion sensor configured to sense a state of corrosion of component 10, as disclosed in U.S. application Ser. No. 15/618,542, Attorney Docket Number G0766.70122US01, the disclosure of which is hereby incorporated by reference in its entirety. In another example, sensor 100 may include a sensing element comprising a material which permanently changes state in connection with a permanent change in state of an aircraft, thus recording the condition of the aircraft during flight without being powered. Subsequently to flight, data on the sensed condition of the aircraft can be transmitted via a wireless data link to a reader, as disclosed in U.S. application Ser. No. 16/268,437, Attorney Docket Number G0766.70274US00, the disclosure of which is hereby incorporated by reference in its entirety.

In FIG. 1, reader 200 is used by operator 202 to interrogate data measured by sensor 100. Reader 200 may be a radio-frequency (RF) reader, and may be configured as a portable or handheld reader device. Reader 200 may wirelessly transmit a power signal to power operation of sensor 100, for example via signal 206a. Control and data signals may additionally be transmitted from reader 200 to sensor 100 as well. Reader 200 may receive a signal 206b from sensor 100. Signal 206b may comprise a data signal associated with a sensed condition of the component 10. Signal 206b may also comprise a data signal associated with one or more states of sensor 100, such as a state of charge of an energy storage unit within the sensor 100. Signals 206a, 206b may be RF signals, and be of any suitable frequency band and modulation scheme.

According to a non-limiting manner of operation, the operator 202 may interrogate a recorded condition from the sensor 100 that is representative of a sensed environmental or structural condition of component 10. For example, operator 202 may be a maintenance technician using reader 200 to interrogate sensor 100 to obtain sensed corrosion or cracking condition of an aircraft body material, on which sensor 100 has been affixed to. During operation, operator 202 may bring the reader 200 in close proximity to the sensor 100 and depress a button on the reader 200, causing the reader 200 to emit an RF signal 206a. In some embodiments, the RF signal 206a may be a power signal that is received by sensor 100 to power circuitry inside sensor 100. RF signal 206a may initiate a cold start of sensor 100, or otherwise activate sensor 100 from a non-powered state to transmit data signal 206b to the reader 200.

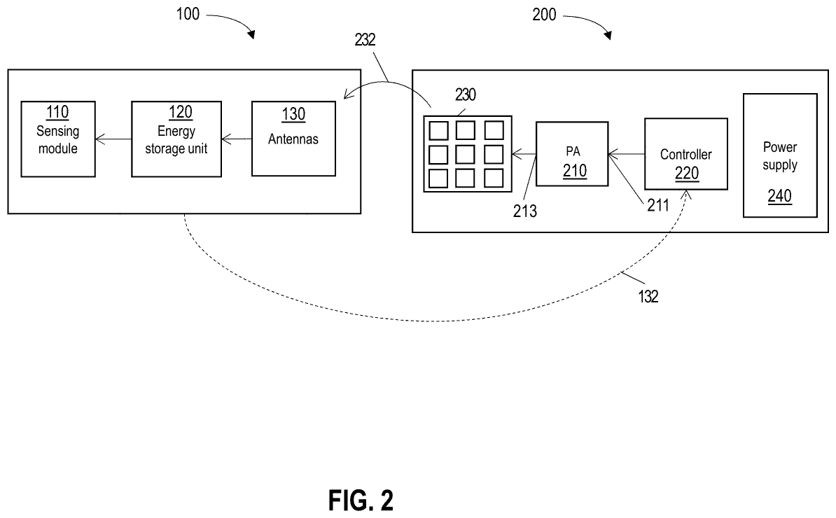

FIG. 2 is a schematic diagram of an exemplary reader that can be used in the manner of FIG. 1 to interrogate a sensor, in accordance with some embodiments. FIG. 2 shows a reader 200 that comprises a PA 210, a controller 220, antennas 230, and a power supply 240. FIG. 2 also shows an exemplary sensor 100 that comprises a sensing module 110, an energy storage unit 120 and antennas 130.

In FIG. 2, reader 200 can transmit a power signal 232 to supply power wirelessly to sensor 100. An output 213 of the PA 210 is coupled to antennas 230 to generate the power signal 232 for broadcast by antennas 230. Antennas 230 may be any suitable type of RF antennas and may comprise more than one physical antennas, such as but not limited to an array of patch antennas on a substrate. Power signal 232 may be generated with a suitable frequency that can be efficiently broadcast by the antennas 230.

Still referring to FIG. 2, controller 220 is coupled to a gain control terminal 211 of the PA 210, and can adjust a magnitude of the power signal 232 by adjusting an output power of the PA, for example by sending a digital or analog control signal at the gain control terminal 211. PA 210 may generate an output signal at output 213. Controller 220 may be implemented by any suitable analog and digital circuitry. It should be appreciated that one or more functions of controller 220 may be implemented in software, and that embodiments of controller 220 may comprise at least one non-transitory computer-readable storage medium (e.g., a computer memory, a portable memory, etc.) encoded with a computer program (i.e., a plurality of instructions), which, when executed on a processor, performs the above-discussed functions of the controller 220.

A power supply 240 provides power to electrical components within controller 220 and PA 210. Power supply 240 may be any suitable portable power supply, such as a rechargeable battery. In some embodiments, reader 200 may comprise a housing in which the controller 220, PA 210, antennas 230 and power supply 240 are disposed, although it should be appreciated that a portion or an entirety of some components depicted in FIG. 2 within reader 200 may be disposed outside of a housing. For example, an external battery or power source may be used. In some embodiments, part of the controller may be implemented as a separate physical device, for example as part of a portable computer, or as part of a remote processor accessible via cloud communications.

During operation of the reader 200, an operator, for example operator 202 as shown in FIG. 1, holds reader 200 close to sensor 100. FIG. 2 illustrates a highly generalized diagram for sensor 100, where antennas 130 may include transceivers configured to receive the wireless energy signal 232 emitted from the reader 200 and converts the energy signal into energy for storage in the energy storage unit 120, which may be a rechargeable battery or a capacitor. As energy storage unit 120 is charged sufficiently to provide the voltage and current for operation of circuitry within sensing module 110, sensor 100 may operate to transmit an indication signal 132 to the controller 220. The indication signal 132 may be a data signal that communicates to the reader 200 data representing a sensed condition of an environment or a structure as measured by the sensing module. The indication signal 132 may also communicate to the reader 200 a state of charge of the energy storage unit 120 within the sensor. The state of charge may be for example a voltage, a current or a level of charge.

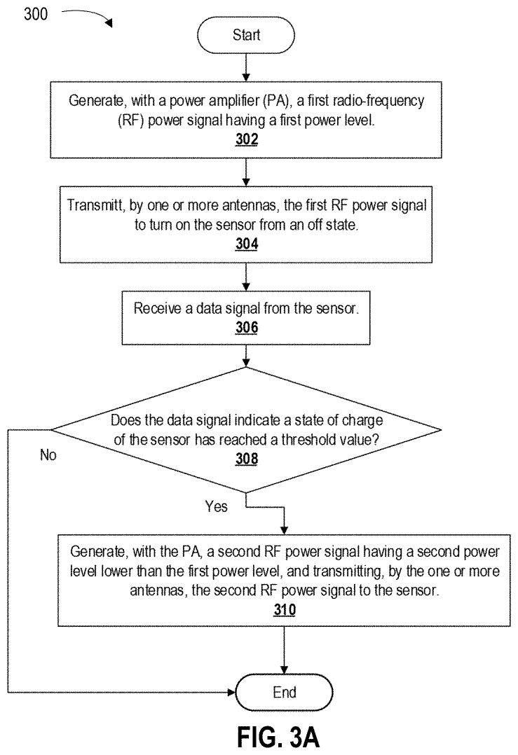

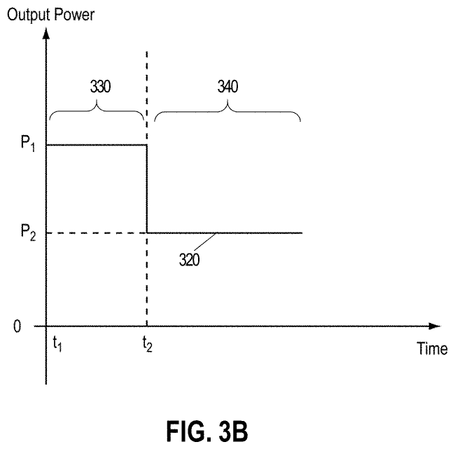

FIG. 3A is a flow diagram illustrating an exemplary process for operating a handheld reader of the type as illustrated in FIG. 2, in accordance with some embodiments. As shown in FIG. 3A, process 300 starts with generating a first RF power signal using the PA of the reader 200 (act 302). At act 304, reader 200 transmits the first RF power signal via one or more antennas 230 to power sensor 100 wirelessly to turn sensor 100 from an off state to an on state, or otherwise “cold start” sensor 100. The first RF power signal may be generated at a high power level, such that the energy storage unit 120 within sensor 100 is recharged quickly to resume sensor operation in a short amount of time. Subsequently at act 306, reader 200 receives an indication signal 132 from the sensor 100, and at act 308 determines if the indication signal 132 contains an indication that a state of charge of the sensor 100 has reached a threshold value. The determination at act 308 may be performed for example in controller 220 of reader 200. If the result of act 308 is positive, then at act 310 the process generates a second RF power signal that has a lower power level than the first RF power signal, and transmits the second RF power signal via one or more antennas 230 to sensor 100. For example, if the indication signal 132 indicates that the energy storage unit 120 has reached sufficient charge and can sustain operation of the rest of the components in sensor 100 without requiring the high power level RF power signal from the reader 200, controller 220 may adjust the output power of PA 210 to generate a lower power level RF power signal, to preserve battery life of the power supply 240.

FIG. 3B is a simulated data plot of an output power of a power signal as a function of elapsed time, in accordance with some embodiments. In FIG. 3B, curve 320 is a simulated output power of a power signal such as power signal 232 as shown in FIG. 2 during an exemplary operation of a reader such as process 300 as shown in FIG. 3A. At time t₁, a start-up period 330 commences to generate and transmit a first power level P₁ to cold-start a sensor according to act 302 in FIG. 3A. The start-up period continues until time t₂, when the reader receives an indication signal from the sensor indicating that a state of charge of the sensor has reached a threshold value according to acts 306 and 308. In response and after time t₂, the reader lowers the output power of the power signal to a second power level P₂ according to act 310. The reader can be viewed as entering a steady state operation period on and after time t₂.

The levels of the power signal P₁ and P₂ may be pre-determined prior to operating the reader, and stored in a memory of the controller 220. For example, a calibration process may be carried out using reader 200 and a sensor 100 in standardized conditions to determine P₁ such that a cold start can be started quickly, and to determine P₂ such that energy storage unit 120 can be continuously drained to power operation of sensor 100 without interruption. However, it should be appreciated that other methods of setting the levels of P₁ and P₂ may be used. For example, the second power level P₂ may be set dynamically based on the indication signal 132 received from the sensor 100 during operation.

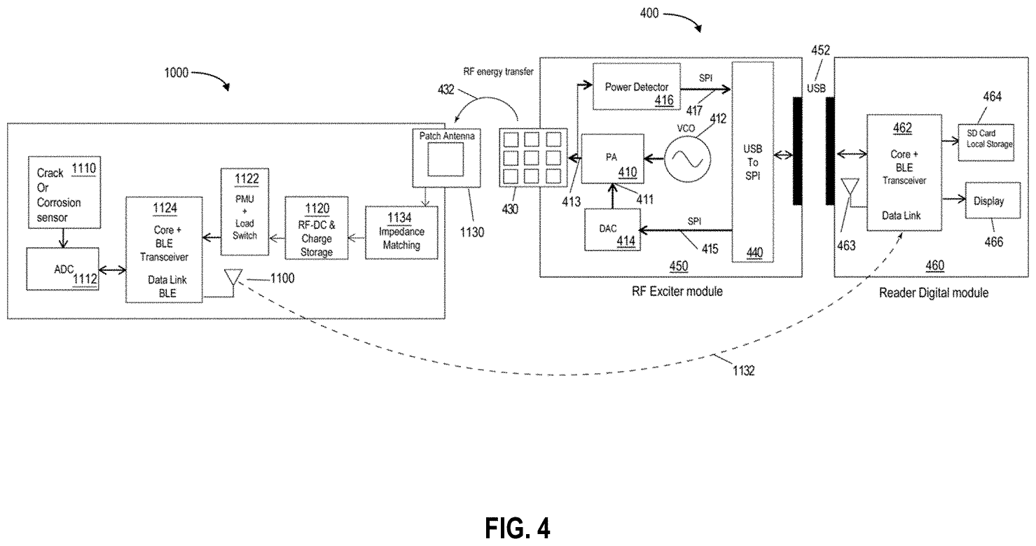

FIG. 4 is a schematic diagram illustrating an exemplary implementation of a reader for interrogating a sensor, in accordance with some embodiments. In FIG. 4, reader 400 comprises a RF exciter module 450 and a reader digital module 460. The RF exciter module 450 includes a PA 410, antennas 430, and a power detector 416. RF exciter module 450 also includes a digital-to-analog converter (DAC) 414, a voltage-controlled oscillator (VCO) 412, and a controller interface 440. In the reader digital module 460, a controller 462 is coupled to a local storage 464 and a display 466.

As shown in FIG. 4, PA 410 generates a power signal 432 for transmission by antennas 430 via an output 413 of the PA 410. Antennas 430 may be a plurality of patch antennas in a non-limiting example. The magnitude of power signal 432 may be adjusted proportionally using a power amplifier gain of PA 410, for example by using DAC 414 to provide at an analog output of the DAC an analog gain control signal to a gain control input terminal 411 of the PA 410. Controller interface 440 sends a digital control signal 415 to DAC 414 to adjust the gain of PA 410 such that the magnitude of power signal 432 may be set and maintained at a pre-determined level.

Still referring to FIG. 4, the magnitude of power signal 432 is proportional to an output power of PA 410, which is monitored by a power detector 416 that is coupled to the output 413 of the PA 410. Controller interface 440 receives the power detector output signal 417 representing the monitored output power of PA 410. Controller interface 440 is part of a feedback loop that includes the power detector, the controller interface 440, the DAC 414 and the PA 410 such that the power amplifier gain of PA 410 may be adjusted to compensate for variations in the monitored output power, for example due to output power loss that tends to occur when the PA heats up.

Still referring to FIG. 4, the frequency of power signal 432 may be controlled by VCO 412, which generates a RF signal of a pre-determined frequency that is optimized for transmission using antennas 430. The frequency for power signal 432 may be between 2 and 6 GHz, although other values may be used. Components in the RF exciter module 450 may be powered by a battery (not shown).

In the example shown in FIG. 4, the reader digital module 460 includes a controller 462 that is in communication with the controller interface 440 of the RF exciter module 450. For example, controller 462 may communicate with controller interface 440 via the universal serial bus (USB) protocol across a USB connection 452, and the controller interface 440 may communicate with power detector 146 and DAC 414 using a serial parallel interface (SPI) protocol. It should be appreciated that FIG. 4 only illustrates a non-limiting example of how reader 400 may be implemented, and that aspects of the present application are not limited to what protocol(s) controller 462 uses to communicate with the rest of the reader components. In some embodiments, controller interface 440 is optional and may be eliminated if controller 462 is directly communicating with DAC 414 and power detector 416 as an example.

In FIG. 4, controller 462 may communicate with local storage 464 to store and retrieve data, and with display 466 to provide visual feedback to an operator. Controller 462 may comprise one or more processors, additional memories. In some embodiments, controller 462 may comprise one or more transceivers coupled with antennas 463 for direct data link with a sensor 1000 to receive an indication signal 1132. The data link may use a different frequency than that used by the power signal 432 for wireless energy transfer. For example, the power signal 432 and indication signal 1132 may each comprise a signal having a different frequency in the industrial, scientific and medical (ISM) band. The inventors have appreciated and recognized that operating the wireless power transfer and data link in two separate frequency bands can avoid the RF energy transfer from blocking the wireless data link. In one non-limiting example, the data link may be a Bluetooth® data link and indication signal 1132 may be communicated between sensor 1000 and reader 400 using Bluetooth® protocol, although other suitable communication protocols may be used.

Turning now to the exemplary sensor 1000 shown in FIG. 4, which comprises a patch antenna 1130, an impedance matching circuit 1134, an energy storage unit 1120, a power management unit (PMU) and load switch 1122, a controller 1124, ADC 1112 and a sensing element 1110, which may be a nanostructure sensor of the type disclosed in U.S. application Ser. No. 16/268,437, Attorney Docket Number G0766.70274US00, the disclosure of which is hereby incorporated by reference in its entirety. Sensing element 1110 may sense conditions which represent a permanent change in state of a structure, such as a state of corrosion or cracking.

The sensor 1000 in FIG. 4 may be a passive sensor, and in some embodiments, the sensor 1000 may lack a battery or local power source, and may harvest RF energy to power its operations. Patch antenna 1130 may receive a wireless power signal such as power signal 432 from an external device such as reader 400. The impedance matching circuit 1134 may perform an impedance matching function to optimize the efficiency of patch antenna 1130 to receive power signal 432. The received power signal may be converted to a DC signal and stored in energy storage unit 1120. Energy storage unit 1120 may comprise a rechargeable battery or a capacitor having a voltage that increases proportionally with the state of charge of the battery or capacitor. In one example, sensor 1000 may not be read for an extended period of time such as a week or a month, and a capacitor voltage may be zero. During a cold start of such a sensor 1000, the capacitor voltage may increase to more than 1.8V in response to the wireless energy transfer from reader 400, after which the energy storage unit 1120 may provide sufficient voltage and current to power the rest of the components in sensor 1000 electrically. In this non-limiting example, a capacitor voltage of 1.8V within the energy storage unit 1120 may be set as a threshold indicating that the energy storage unit 1120 has been charged sufficiently. It should be appreciated that the threshold voltage may be set at a value between 1 and 5 V, between 1.8 and 2.5 V, or any suitable value that is representative of a sufficient state of charge of a capacitor for powering sensor 1000 after cold start.

Energy storage unit 1120 provides a direct current (DC) signal to the PMU and load switch 1122 to power circuitry in the controller 1124. Controller 1124 may operate to read a state of the sensing element 1110 when activated by the load switch. The ADC 1112 may receive an analog signal from the sensing element 1110 and convert it to a digital signal. Thus, the ADC 1112 may generate a digital representation of the measured signal of the condition recorded by the sensing element 1110. A processor core within controller 1124 may process the digital signal in any suitable manner. The ADC 1112, controller 1124, PMU and load switch 1122, energy storage unit 1120 and impedance matching circuit 1134 may be implemented as one or more microelectronics package within the sensor 1000.

It should be appreciated from the illustrated embodiment of FIG. 4 that in some embodiments a sensor of the types described herein may include multiple antennas. One may function as an energy harvesting antenna. Another may operate as part of a data link to receive and transmit indication signals. For example, a separate antenna 1100 may be coupled to controller 1124 to provide digital data link with a reader 400, such as using Bluetooth® communication protocol. Furthermore, in some embodiments the patch antenna 1130 and antenna 1100 may operate in different ISM bands. For example, the patch antenna 1130 may operate in a first ISM band for wireless power transfer and the antenna 1100 may operate in a second ISM band. Alternatively, in some embodiments, the two antennae may operate in the same ISM band.

As described previously with respect to FIG. 3A, reader 400 can be operated to interrogate sensor 1000 in a manner that can save battery power in the reader 400. For example, during cold start for sensor 1000, controller 462 may control PA 410 to generate a power signal 432 with a high power to quickly charge a capacitor within energy storage unit 1120 of sensor 1000. When the capacitor voltage is charged to a sufficient level, controller 1124 within sensor 1000 may transmit an indication signal 1132 indicating that that the capacitor voltage has reached a pre-determined threshold. In some embodiments, indication signal 1132 may indicate a value representing a state of charge of the energy storage unit 1120 of sensor 1000, and comparison with a threshold may occur within controller 462 of the reader side. In response, reader 400 may transmit a lower power level to conserve battery life.

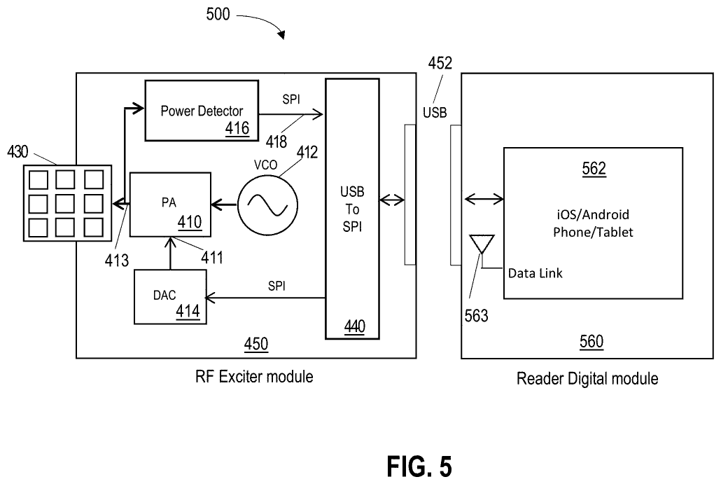

FIG. 5 is a schematic diagram of a reader apparatus that is a variation of the reader as shown in FIG. 4, in accordance with some embodiments. In FIG. 5, reader 500 is similar to reader 400 of FIG. 4 in some aspects, with like components represented by the same reference numbers. Reader 500 differs from reader 400 in that reader 500 includes a reader digital module 560 that comprises a portable computing device 562. Portable computing device 562 may be a smartphone, a tablet, or a portable computer that has antenna 563 to establish a data link with a sensor 1000, and can communicate with RF exciter module 450 via USB connection 452. It should be appreciated that any suitable means may be used for portable computing device 562 to communicate with components within RF exciter module 450 of reader 500.

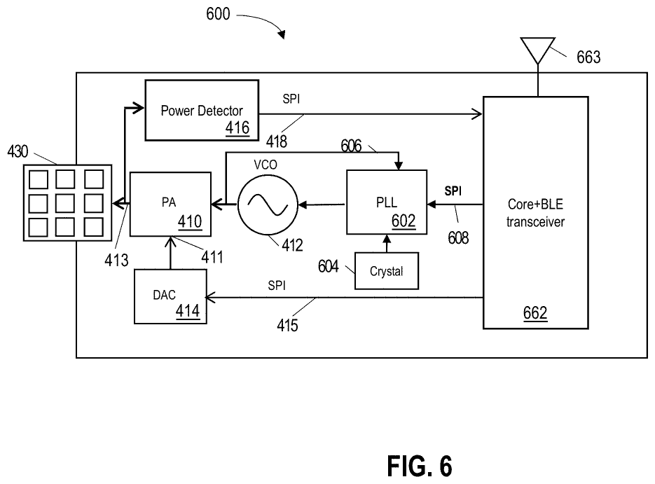

FIG. 6 is a schematic diagram of a reader apparatus that is another variation of the reader as shown in FIG. 4, in accordance with some embodiments. In FIG. 6, reader 600 is similar to reader 400 of FIG. 4 in some aspects, with like components represented by the same reference numbers. Reader 600 differs from reader 400 in that reader 600 includes a controller 662 that is directly connected to power detector 416 and DAC 414. Reader 600 also includes a phase-locked loop (PLL) 602 coupled to a crystal 604 and to VCO 412. PLL 602 and VCO 412 form part of a frequency feedback loop 606 that maintains the oscillation frequency at an output of the VCO at a pre-determined frequency value, thereby maintaining the frequency of power signal 432 at the pre-determined frequency value. Keeping the power signal frequency constant via feedback loop 606 can reduce frequency wandering during operation, maintain peak power transfer efficiency and compliance with Federal Communication Commission (FCC) regulations on frequency usage. The frequency of power signal 432 may be adjusted by controller 662 by a control signal 608. For example, controller 662 may set the frequency of power signal 432 at a value that is optimized for power transfer via antennas 430. Controller 662 may comprise a processor and a bluetooth transceiver that is configured to work with antenna 663 to receive indication signals transmitted by a sensor.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. A portable reader for wirelessly interrogating a sensor, the portable reader comprising:
one or more antennas configured to transmit a power signal to the sensor and to receive an indication signal from the sensor;
a power amplifier (PA) configured to generate the power signal for transmission by the one or more antennas; and
a controller configured to reduce a magnitude of the power signal in response to an indication from the indication signal that a state of charge of the sensor reaches a threshold value.

2. The portable reader of claim 1, wherein the state of charge of the sensor is a state of charge of an energy storage unit in the sensor, wherein the portable reader is configured to charge the energy storage unit via the transmitted power signal.

3. The portable reader of claim 2, wherein the threshold value for the state of charge of the energy storage unit is a threshold value for supporting a steady state operation of the sensor.

4. The portable reader of claim 1, wherein the controller is configured to receive the indication from the indication signal that the state of charge of the sensor reaches the threshold value via a bluetooth data link.

5. The portable reader of claim 1, wherein
the controller comprises a digital-to-analog convertor (DAC) having an analog output coupled to a gain control input terminal of the PA.

6. The portable reader of claim 5, further comprising:
a detector configured to monitor an output power of the PA, wherein the controller is configured to adjust an analog signal at the gain control input terminal of the PA in response to a change in the monitored output power, such that the output power is maintained at a pre-determined level.

7. The portable reader of claim 1, further comprising:
a voltage-controlled oscillator coupled to the PA and configured to modulate a frequency of the power signal, wherein
the voltage-controlled oscillator is part of a phase-locked loop (PLL) that is configured to maintain the frequency of the power signal at a pre-determined frequency.

8. The portable reader of claim 1, wherein
the one or more antennas in the portable reader are configured to transmit the power signal and receive the indication signal at two different frequencies in the industrial, scientific and medical (ISM) band.

9. An apparatus for wirelessly interrogating a structural sensor affixed to a structure, the structural sensor comprising an energy storage unit configured to be charged by a radio-frequency (RF) power signal, the apparatus comprising:
one or more antennas;
a power amplifier (PA) configured to generate the RF power signal for transmission to the structural sensor via the one or more antennas; and
a controller coupled to a control terminal of the PA and configured to decrease a magnitude of the generated RF power signal in response to an indication signal received from the structural sensor indicating that a state of charge of the energy storage unit in the structural sensor reaches a threshold value.

10. The apparatus of claim 9, wherein
the controller is configured to receive the indication signal indicating that a state of charge of the energy storage unit in the structural sensor reaches the threshold value via a bluetooth data link.

11. The apparatus of claim 9, wherein
the control terminal is a gain control terminal of the PA, and
the controller comprises a digital-to-analog convertor (DAC) having an analog output coupled to the control terminal of the PA.

12. The apparatus of claim 11, further comprising:
a detector configured to monitor an output power of the PA, wherein
the controller is configured to adjust the analog output of the DAC in response to a change in the monitored output power, such that the output power is maintained at a pre-determined level.

13. The apparatus of claim 9, further comprising:
an oscillator coupled to the PA and configured to modulate a frequency of the RF power signal.

14. The apparatus of claim 13, wherein the oscillator is a voltage-controlled oscillator, and
the oscillator is part of a phase-locked loop (PLL) that is configured to maintain the frequency at a pre-determined level.

15. The apparatus of claim 9, wherein
the one or more antennas are configured to transmit the RF power signal and receive the indication signal at two different frequencies in the industrial, scientific and medical (ISM) band.

16. A method for operating a handheld reader to interrogate a sensor, the method comprising:
generating, with a power amplifier (PA), a first radio-frequency (RF) power signal having a first power level;
transmitting, by one or more antennas, the first RF power signal to turn on the sensor from an off state;
receiving a data signal from the sensor;
determining whether the data signal indicates that a state of charge of the sensor has reached a threshold value; and
in response to determining that the data signal indicates the state of charge of the sensor has reached the threshold value:
generating, with the PA, a second RF power signal having a second power level lower than the first power level, and
transmitting, by the one or more antennas, the second RF power signal to the sensor.

17. The method of claim 16, wherein receiving a data signal from the sensor comprises:
receiving the data signal from the sensor via a bluetooth data link.

18. The method of claim 16, further comprising:
monitoring an output power of the PA with a detector, and
adjusting a gain of the PA in response to a change in the monitored output power, such that the output power is maintained at a pre-determined level.

19. The method of claim 16, wherein generating the first RF power signal comprises:
modulating a frequency of the first RF power signal with a voltage-controlled oscillator that is part of a phase-locked loop (PLL), the PLL configured to maintain the frequency at a pre-determined level.

20. The method of claim 16, wherein
the one or more antennas in the handheld reader is configured to transmit the RF power signal and receive the data signal at two different frequencies in the industrial, scientific and medical (ISM) band.
